(19) United States
(12) Patent Application Publication
(10) Pub. No.: US 2026/0113820 A1
(43) Pub. Date: Apr. 23, 2026

(54) WHITE LIGHT TUNING WITH DUV ADJUSTMENT

(71) Applicant: SIGNIFY HOLDING B.V., EINDHOVEN (NL)

(72) Inventors: RAYMOND GEORGE JANIK, FAYETTEVILLE, GA (US); DANIEL LELAND BRAGG, PEACHTREE CITY, GA (US); RUSSELL SCOTT TRASK, SHARPSBURG, GA (US)

(21) Appl. No.: 19/117,983

(22) PCT Filed: Oct. 5, 2023
(86) PCT No.: PCT/EP2023/077600

§ 371 Date: Apr. 3, 2025

Related U.S. Application Data
(60) Provisional application No. 63/415,393, filed on Oct. 12, 2022.

(30) Foreign Application Priority Data
Oct. 20, 2022 (EP) 22202644.5

(51) Int. Cl. H05B 45/20; H05B 45/30; H05B 47/105; H05B 47/155; H05B 47/165

(52) U.S. Cl. CPC H05B 45/20; H05B 45/30; H05B 47/105; H05B 47/155; H05B 47/165

(57) ABSTRACT

A lighting device includes warm Correlated Color Temperature (CCT) light emitting diodes (LEDs) configured to emit a warm white light and cool CCT LEDs configured to emit a cool white light. The lighting device further includes green light LEDs configured to emit a green light having a green light flux controlled based on a flux of the cool white light or a flux of the warm white light, where values corresponding to the green light flux are obtained from a lookup table. The lighting device further includes delta u,v (Duv) adjustment LEDs configured to emit a Duy adjustment light having an adjustment total flux that includes an adjustment flux amount having a maximum flux value determined by iteratively adjusting the adjustment flux amount until a Duy of a combined light that includes the warm white light and the Duy adjustment light is less than a threshold value.

### TECHNICAL FIELD

The present disclosure relates generally to lighting solutions, and more particularly to white light tuning with delta u,v (Duv) adjustment.

### BACKGROUND

The Correlated Color Temperature (CCT) of a white light emitted by a light emitting diode (LED) lighting fixture may be changed, for example, by changing the CCT setting of the light fixture. For example, the CCT of a light emitted by a light fixture may adjusted between a warm CCT (e.g., 2700-3000 K) and a cool CCT (e.g., 5000 K-6500 K), inclusive. For example, white light color tuning may be performed by combining warm white light and cool white light, resulting in a combined light with a resultant CCT that depends on the fluxes of the two lights. On a chromaticity chart, the resultant CCT sits on a straight line joining the CCT of the warm white light and the CCT of the cool white light. To produce a combined white light with CCT values that are closer to the black-body radiation curve (BBC), a CCT adjustment light (e.g., a green light) may be combined with a warm white light and a cool white light by controlling the flux of the CCT adjustment light based on a lookup table. However, if the flux of the CCT adjustment light in a lookup table is determined based on the warm CCT and the cool CCT being on the BBC curve or having a delta u,v (Duv) of near zero, the adjustment resulting from the addition of the green light may not produce a desired result. For example, warm white lights emitted by different LEDs can often be several steps of standard deviation of color matching (SDCM) (or MacAdam steps) away from each other and from a warm CCT value (e.g., 2700K) that is on the BBC curve. Cool white lights emitted by different LEDs can also often be several steps of SDCM away from each other and from a cool CCT value (e.g., 6500K) that is on the BBC curve. Thus, a solution that enables the use of a lookup table to more reliably reduce the departure of a white light tuning curve from the BBC is desirable.

### SUMMARY

The present disclosure relates generally to lighting and location-based systems, and more particularly to lighting solutions, and more particularly to white light tuning. In an example embodiment, a lighting device includes warm CCT light emitting diodes (LEDs) configured to emit a warm white light having a warm CCT value and cool CCT LEDs configured to emit a cool white light having a cool CCT value. The lighting device further includes green light LEDs configured to emit a green light having a green light flux. The green light flux is controlled based on a flux of the cool white light or a flux of the warm white light, where values corresponding to the green light flux are obtained from a lookup table that includes the values corresponding to the green light flux and values corresponding to the flux of the cool white light or the flux of the warm white light. The lighting device further includes delta u,v (Duv) adjustment LEDs configured to emit a Duv adjustment light having an adjustment total flux that includes an adjustment flux amount. The adjustment flux amount has a maximum flux value that is determined by iteratively adjusting the adjustment flux amount, while the cool white light and the green light are off, until a Duv of a combined light that includes the warm white light and the Duv adjustment light is less than a threshold value. After the maximum flux value is determined, the adjustment flux amount is controlled based on the maximum flux value and based on the values corresponding to the flux of the cool white light or the values corresponding to the flux of the warm white light.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates white light tuning path curves relative to the black body curve (BBC) in the CIE 1976 Uniform Color Space according to an example embodiment;

FIG. 2 illustrates a system including a lighting device and a Duv measurement device for determining maximum flux value of Duv adjustment flux according to an example embodiment; and

FIG. 3 illustrates the system of FIG. 2 including details of the lighting device according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different figures designate like or corresponding, but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

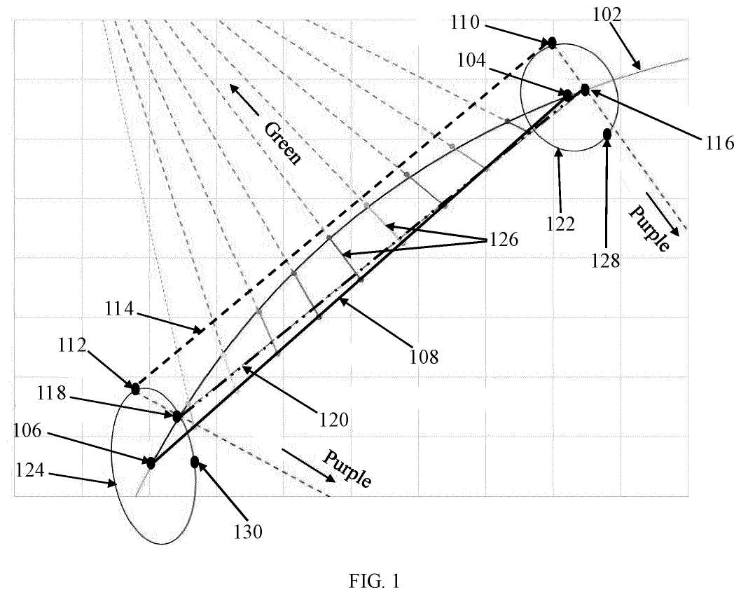

FIG. 1 illustrates white light tuning path curves relative to the black body curve (BBC) 102 in the CIE 1976 Uniform Color Space according to an example embodiment. In some example embodiments, a warm CCT point 104 is on the BBC 102 and may correspond to a warm CCT value (e.g., 2700K, 3000K, another value in a range of 2500K to 3000K). The CCT point 104 may be inside a MacAdam ellipse 122. For example, the warm CCT point 104 may be a center value (i.e., a warm CCT center value) of the MacAdam ellipse 122. A cool CCT point 106 may be on the BBC 102 and inside a MacAdam ellipse 124. The cool CCT point 106 may correspond to a cool CCT value (e.g., 6000K, 6500K, another value in a range of 6000K to 7000K). For example, the cool CCT point 106 may be a center value (i.e., a cool CCT center value) of the MacAdam ellipse 124. The MacAdam ellipse 122 and the MacAdam ellipse 124 may each be a 3-step, 5-step, or 7-step MacAdam ellipse.

A white light tuning that is performed strictly based on a warm white light that has a warm CCT value (e.g., at the warm CCT point 104) and a cool white light that has a cool CCT value (e.g., at the cool CCT point 106) may follow a white light tuning curve 108. That is, a combined light resulting from the mixing of the warm white light and the cool white light has a CCT that is on the white light tuning curve 108. For example, white light tuning that follows the white light tuning curve 108 may be based on user CCT setting inputs. As can be seen in FIG. 1, the departure of the white light tuning curve 108 from the BBC 102 is larger for CCT values on the white light tuning curve 108 that are farther away from the warm CCT and the cool CCT.

In some example embodiments, a white light tuning may be performed by introducing a third light. For example, a lookup table may be used to add a third light to the mix of the warm white light and the cool white light to reduce the departure of a white light tuning curve from the BBC. For example, U.S. Pat. No. 10,863,599, which is incorporated herein by reference, describes the generation of lookup tables and the use of a lookup table for introducing a green light (i.e., a phosphor converted green light, which may also be referred to as a lime light). To illustrate, a lookup table stored in a memory device and that includes values corresponding to the flux of a cool white light (e.g., CCT value of 6500K) in association with respective values corresponding to the flux of a green light may be used to control the amount of the flux of the green light that is combined with the warm white light and the cool white light to perform white light tuning.

Table 1 below is an example lookup table that includes values corresponding to the flux of a warm white light, Ø_{2700K}, (warm flux), the flux of a cool white light, Ø_{6500K}, (cool flux), and the flux of a green light, ØG, (green flux). For example, the values in Table 1 may be percentage values with respect to the sum of the warm flux Ø_{2700K} and the cool flux Ø_{6500K}, where the sum of the two is 100%. The values in Table 1 may be used to control the amount of the green flux OG that is combined with the warm flux Ø_{2700K} and the cool flux Ø_{6500K} to perform white light tuning that follows a white light tuning curve with a smaller departure from the BBC than the white light tuning curve 108. In FIG. 1, lines such as lines 126 illustratively show the amount of green flux Ø_{G} that needs to be introduced to result in a white light tuning curve that matches the BBC 102.

To illustrate, the amount of the green flux Ø_{G} that is introduced may be controlled based on the amount of the warm flux Ø_{2700K} as determined, for example, based on the current flowing through warm CCT LEDs that emit the warm white light or based on a user CCT setting input. For example, as shown in Table 1, when 10% of the sum of the warm flux Ø_{2700K} and the cool flux Ø_{6500K} is contributed by the warm flux Ø_{2700K}, the green light may be controlled such that the amount of the green flux OG is 4.4% of the sum of the warm flux Ø_{2700K} and the cool flux Ø_{6500K}. As another example, when 70% of the sum of the warm flux Ø_{2700K} and the cool flux Ø_{6500K} is contributed by the warm flux Ø_{2700K}, the green light may be controlled such that the amount of the green flux OG is 9.3% of the sum of the warm flux Ø_{2700K} and the cool flux Ø_{6500K}.

Alternatively, the amount of the green flux Ø_{G} that is introduced may be controlled based on the amount of the cool flux Ø_{6500K} as determined, for example, based on the current flowing through cool CCT LEDs that emit the cool white light or based on a user CCT setting input. For example, as shown in Table 1, when 10% of the sum of the warm flux Ø_{2700K} and the cool flux Ø_{6500K} is contributed by the cool flux Ø_{6500K}, the green light may be controlled such that the amount of the green flux OG is 4.4% of the sum of the warm flux Ø_{2700K} and the cool flux Ø_{6500K}. As another example, when 70% of the sum of the warm flux Ø_{2700K} and the cool flux Ø_{6500K} is contributed by the warm flux Ø_{2700K}, the green light may be controlled such that the amount of the green flux OG is 8.4% of the sum of the warm flux Ø_{2700K} and the cool flux Ø_{6500K}.

TABLE 1

| φ_{2700K} | φ_{6500K} | φ_{G} |
|---|---|---|
| 0% | 100% | 0.0% |
| 10% | 90% | 4.4% |
| 20% | 80% | 6.7% |
| 30% | 70% | 8.4% |
| 40% | 60% | 9.5% |
| 50% | 50% | 10.0% |
| 60% | 40% | 10.0% |
| 70% | 30% | 9.3% |
| 80% | 20% | 7.7% |
| 90% | 10% | 4.4% |
| 100% | 0% | 0.0% |

In some example embodiments, Table 1 may include duty cycle values, percentage values with respect to others sums (e.g., the sum of the warm flux Ø_{2700K}, the cool flux Ø_{6500K}, and the green flux Ø_{G}), normalized flux values, CCT setting input values, current values, or other values instead of the percentage values with respect to the sum of the warm flux Ø_{2700K} and the cool flux Ø_{6500K}. In general, different types of values corresponding to the warm flux Ø_{2700K} or the cool flux Ø_{6500K} may be mapped to values corresponding to the green flux Ø_{G} and can be used to control the amount of the green flux Ø_{G} that is combined with the warm flux Ø_{2700K} and the cool flux Ø_{6500K} to perform white light tuning that follows a white light tuning curve that has a smaller departure from the BBC than the curve 108.

In some example embodiments, a lookup table, such as the lookup table Table 1, are generated based on the assumption that a warm CCT value (e.g., 2700K) of a warm white light emitted by one or more LEDs is at the location of the warm CCT point 104 and based on the assumption that a cool CCT value (e.g., 6500K) of a cool white light emitted by one or more LEDs is at the location of the cool CCT point 106. That is, based on these assumptions, the values corresponding to the green flux Ø_{G} are generated to reduce the departure of the white light tuning curve 108 from the BBC 102. In reality, the warm CCT value (e.g., 2700K) of the warm white light may be at other locations in the MacAdam ellipse 122 (i.e., including the perimeter of the MacAdam ellipse 122), and the cool CCT value (e.g., 6500K) of the cool white light may be at other locations in the MacAdam ellipse 124 (i.e., including the perimeter of the MacAdam ellipse 124). That is, the departure of the actual white light tuning curve from the BBC 102 that needs to be reduced may be different from the departure of the white light tuning curve 108 from the BBC 102.

To illustrate, the warm CCT value (e.g., 2700K) of a warm white light emitted by one or more LEDs may be at a location 110 in the MacAdam ellipse 122. For example, the location 110 may be 7 steps from the warm CCT point 104, which is the warm CCT center value of the MacAdam ellipse 122. The cool CCT value (e.g., 6500K) of a cool white light emitted by one or more LEDs may be at a location 112 in the MacAdam ellipse 124. For example, the location 112 may be 7 steps from the cool CCT point 106, which is the cool CCT center value of the MacAdam ellipse 124. As clearly shown in FIG. 1, the white light tuning curve 114 connecting the location 110 and the location 112 is above the BBC 102 and different from the white light tuning curve 108 that connects the warm CCT point 104 and the cool CCT point 106. Indeed, because the warm CCT value (e.g., 2700K) of the warm white light may be at a location in the MacAdam ellipse 122 other than at the warm CCT point 104 and because the cool CCT value (e.g., 6500K) of the cool white light may be at a location in the MacAdam ellipse 124 other than at the cool CCT point 106, a white light tuning curve may be above, below, or crossing the BBC 102 and thus different from the white light tuning curve 108. Because the values corresponding to the green flux Ø_{G} in Table 1 are generated to reduce the departure of the white light tuning curve 108 from the BBC 102 (i.e., based on the warm CCT point 104 and/or the cool CCT point 106) and not based on the white light tuning curve 114, reducing the departure of the white light tuning curve 114 from the BBC 102 using the green flux OG in Table 1 may require accounting for the Duv (i.e., the distance from the BBC 102) of the warm white light at the location 110 and the Duv of the cool white light at the location 112.

In some example embodiments, a Duv adjustment light may be added to a warm white light that has the warm CCT value (e.g., 2700K) at the location 110 to produce a combined light that has the warm CCT value (e.g., 2700K) that is in the MacAdam ellipse 122 but a smaller distance from the BBC 102 (i.e., smaller Duv) than the warm CCT value (e.g., 2700K) at the location 110. To illustrate, a purple light (e.g., a mix of a blue light and a red light) may be added to a warm white light having the warm CCT value at the location 110 to produce a combined light that has the warm CCT value with a Duv that is less than a threshold value (e.g., 0.001, 0.003, 0.006) from the BBC 102. In general, the introduction of a purple light to a warm white light and/or a cool white light can result in the CCT value of the resulting light changing in a direction shown by the arrow next to the text “Purple” in FIG. 1. The Duv of the warm CCT value of the combined light depends on the flux of the purple light (purple flux). For example, the purple light may have an adjustment flux amount that can have a maximum flux value with respect to the warm CCT value at the location 110 and that results in the combined light having the warm CCT value in the MacAdam ellipse 122 with a Duv that is less than the threshold value. To illustrate, the maximum flux value of the adjustment flux amount of the purple flux with respect to the warm CCT value can result in the combined light having the warm CCT value (e.g., 2700K) at a location 116 that is in the MacAdam ellipse 122 and on the BBC 102.

In some example embodiments, a Duv adjustment light may be added to a cool white light that has the cool CCT value (e.g., 6500K) at the location 112 to produce a combined light that has the cool CCT value (e.g., 6500K) that is in the MacAdam ellipse 124 but a smaller distance from the BBC 102 (i.e., smaller Duv) than the cool white light with the cool CCT value at the location 112. To illustrate, a purple light (e.g., a mix of a blue light and a red light) may be added to a cool white light having the cool CCT value at the location 112 to produce a combined light that has the cool CCT value with a Duv that is less than a threshold value (e.g., 0.001, 0.003, 0.006) from the BBC 102. The Duv of the cool CCT value of the combined light in the MacAdam ellipse 124 depends on the flux of the purple light (purple flux). For example, the adjustment flux amount (e.g., an amount of the purple flux) can have another maximum flux value with respect to the cool CCT value at the location 112, where the maximum flux value can result in the combined light having the cool CCT value in the MacAdam ellipse 124 with a Duv that is less than the threshold value. The maximum flux value of the adjustment flux amount of the purple flux with respect to the cool CCT value can result in the combined light having the cool CCT value (e.g., 6500K) at a location 118 that is in the MacAdam ellipse 124 and on the BBC 102. A white light tuning curve 120 connects the location 116 and the location 118 and corresponds to a white light tuning path that is based on the combination of the warm flux Ø_{2700K} and the purple flux with respect to the warm CCT value and based on the combination of the cool flux Ø_{6500K} and the purple flux with respect to the cool CCT value.

In general, the Duv adjustment light (e.g., a purple light) may have an adjustment total flux that includes an adjustment flux amount with respect to the warm CCT value (e.g., 2700K) and an adjustment flux amount with respect to the cool CCT value (e.g., 6500K). For example, when the cool white light is off, the warm white light may have a maximum flux value as shown in Table 1 (last row), and the adjustment total flux of the purple light may be the maximum flux value of the purple light with respect to the warm white light that results in the combined light having the warm CCT at the location 116. When the warm white light is off, the cool white light may have a maximum flux value as shown in Table 1 (first row), and the adjustment total flux of the purple light may equal the maximum flux value of the purple light with respect to the cool white light that results in the combined light having the cool CCT at the location 118.

When both the warm white light and the cool white light are on, the adjustment total flux of the purple light may be the sum of a proportion of the maximum flux value of the purple light with respect to the warm white light and a proportion of the maximum flux value of the purple light with respect to the cool white light. The proportion of the maximum flux value of the purple light with respect to the warm white light is determined based on the proportion of the warm flux Ø_{2700K} to the sum of the warm flux Ø_{2700K} and the cool flux Ø_{6500K}. The proportion of the maximum flux value of the purple light with respect to the cool white light is determined based on the proportion of the cool flux Ø_{6500K} to the sum of the warm flux Ø_{2700K} and the cool flux Ø_{6500K} shown in FIG. 1. For example, when 10% of the sum of the warm flux Ø_{2700K} and the cool flux Ø_{6500K} is contributed by the warm flux Ø_{2700K} as shown in Table 1, the adjustment total flux of the purple light may be the sum of 10% of the maximum flux value of the purple light with respect to the warm white light and 90% of the maximum flux value of the purple light with respect to the cool white light. As another example, when 70% of the sum of the warm flux Ø_{2700K} and the cool flux Ø_{6500K} is contributed by the warm flux Ø_{2700K} as shown in Table 1, the adjustment total flux of the purple light may be the sum of 70% of the maximum flux value of the purple light with respect to the warm white light and 30% of the maximum flux value of the purple light with respect to the cool white light.

Table 2 below shows values that correspond to combined fluxes in association with values corresponding to the green flux Ø_{G}. For example, in Table 2, the column labeled Ø_{2700K}-Nulled shows the values corresponding to the combined flux of the warm flux Ø_{2700K} and the proportion of the maximum flux value of the purple light with respect to the warm white light. To be clear, the maximum flux value of the purple light with respect to the warm white light is the maximum flux value of the adjustment flux (i.e., purple flux) amount that results in combination of the warm white light having a warm CCT at the location 110 and the purple light having the warm CCT being at the location 116. For example, the maximum flux value of the purple light with respect to the warm white light may be 4.7% of the warm flux Ø_{2700K}, and the combined flux Ø_{2700K}-Nulled may be 104.7% of the warm flux Ø_{2700K}.

The column labeled Ø_{6500K}-Nulled shows the values corresponding to the combined flux of the cool flux Ø_{6500K} and the proportion of the maximum flux value of the purple light with respect to the cool white light. The maximum flux value of the purple light with respect to the cool white light is the maximum flux value of the adjustment flux (i.e., purple flux) amount that results in combination of the cool white light having a cool CCT at the location 112 and the purple light having the cool CCT being at the location 118. For example, the maximum flux value of the purple light with respect to the cool white light may be 4% of the cool flux Ø_{6500K}, and the combined flux Ø_{6500K}-Nulled may be 104% of the cool flux Ø_{6500K}. As another example, when the cool flux Ø_{6500K} is 90% (i.e., second row in Table 1) of the sum of the warm flux Ø_{2700K} and the cool flux Ø6500K, 90% of the maximum flux value of the purple light with respect to the cool white light may be combined with the 90% of the cool flux Ø_{6500K} resulting in the combined flux Ø_{6500K}-Nulled having the value shown in the second row of the Table 2. When the cool flux Ø_{6500K} is 90% (i.e., the warm flux Ø_{2700K} is 10% of the sum of the warm flux Ø_{2700K} and the cool flux Ø_{6500K}), 10% of the maximum flux value of the purple light with respect to the warm white light may be combined with the 10% of the warm flux Ø_{2700K} resulting in the combined flux Ø_{2700K}-Nulled having the value shown in the second row of the Table 2. When the cool flux Ø_{6500K} is 90% and the warm flux Ø_{2700K} is 10%, the adjustment total flux of the purple light is the sum of 90% of the maximum flux value of the purple light with respect to the cool white light and 10% of the maximum flux value of the purple light with respect to the warm white light.

TABLE 2

| φ_{2700K - Nulled} | φ_{6500K - Nulled} | φ_{G} |
|---|---|---|
| 0.000% | 104.0% | 0.0% |
| 10.05% | 93.23% | 4.4% |
| 20.19% | 82.55% | 6.7% |
| 30.42% | 71.96% | 8.4% |
| 40.75% | 61.44% | 9.5% |
| 51.17% | 51.00% | 10.0% |
| 61.69% | 40.64% | 10.0% |
| 72.30% | 30.36% | 9.3% |
| 83.01% | 20.16% | 7.7% |
| 93.81% | 10.04% | 4.4% |
| 104.7% | 0.000% | 0.0% |

As described above, the green flux OG may be combined with the warm flux Ø_{2700K} and/or the cool flux Ø_{6500K}. With the introduction of the purple light (or another Duv adjustment light), the green flux Ø_{G} may be combined with the combined flux Ø_{2700K}-Nulled and the combined flux Ø_{6500K}-Nulled such that the CCT of the overall combined light is closer than the white light tuning curve 108 and the white light tuning curve 120 to the BBC 102 shown in FIG. 1.

In some example embodiments, a warm white light may have the warm CCT value (e.g., 2700K), for example, at a location 128 in the MacAdam ellipse 122 below the BBC 102. Another Duv adjustment light may be added to the warm white light that has the warm CCT value at the location 128 to produce a combined light that has the warm CCT value (e.g., 2700K) in the MacAdam ellipse 122 but with a smaller Duv than the warm CCT value at the location 128. To illustrate, a second green light (e.g., another green light in addition to the green light described with respect to Table 1 and Table 2) may be added to a warm white light having the warm CCT value at the location 128 to produce a combined light that has the warm CCT value with a Duv value that is less than a threshold value (e.g., 0.001, 0.003, 0.006) from the BBC 102. In general, the introduction of a second green light to a warm white light and/or a cool white light can result in the CCT value of the resulting light changing in a direction shown by the arrow next to the text “Green” in FIG. 1. The Duv of the warm CCT value of the combined light in the MacAdam ellipse 122 depends on the flux of the second green light. For example, the second green light may have an adjustment flux amount having a maximum flux value with respect to the warm CCT value at the location 128 and that results in the combined light having the warm CCT value in the MacAdam ellipse 122 with a Duv that is less than the threshold value. In some alternative embodiments, instead of a green flux of a second green light, an increased green flux amount (i.e., resulting in an increased amount of the green flux Ø_{G} described with respect to Table 1 and Table 2) may be combined with the warm flux Ø_{2700K}.

In some example embodiments, a cool white light may have the cool CCT value (e.g., 6500K), for example, at a location 130 in the MacAdam ellipse 124 below the BBC 102. Another Duv adjustment light may be added to the cool white light that has the cool CCT value at the location 130 to produce a combined light that has the cool CCT value (e.g., 6500K) in the MacAdam ellipse 124 but with a smaller Duv than the cool CCT value at the location 130. To illustrate, the second green light may be added to a cool white light having the cool CCT value at the location 130 to produce a combined light that has the cool CCT value with a Duv value that is less than a threshold value (e.g., 0.001, 0.003, 0.006) from the BBC 102. The Duv of the cool CCT value of the combined light in the MacAdam ellipse 124 depends on the flux of the second green light. For example, the second green light may have an adjustment flux amount having a maximum flux value with respect to the cool CCT value at the location 130 and that results in the combined light having the cool CCT value in the MacAdam ellipse 124 with a Duv that is less than the threshold value. In some alternative embodiments, instead of a green flux of a second green light, an increased green flux amount (i.e., resulting in an increased amount of the green flux Ø_{G} described with respect to Table 1 and Table 2) may be combined with the cool flux Ø_{6500K}. In general, the second green light may have an adjustment total flux that includes an adjustment flux amount with respect to the warm CCT value (e.g., 2700K) that is at the location 128 and/or an adjustment flux amount with respect to the cool CCT value (e.g., 6500K) that is at the location 130.

As described above, the green flux Ø_{G} described with respect to Table 1 may be combined with the warm flux Ø_{2700K} and/or the cool flux Ø_{6500K} such that a resulting white light tuning curve is relatively closer than the white light tuning curve 108 to the BBC 102. With the introduction of the second green light, the green flux Ø_{G} described with respect to Table 1 may be combined with the combined flux Ø_{2700K}-Nulled (i.e., the combination of the warm flux Ø_{2700K} and the respective flux of the second green light) and the combined flux Ø_{6500K}-Nulled (i.e., the combination of the cool flux Ø_{6500K} and the respective flux of the second green light) such that the CCT of the overall combined light is closer than the white light tuning curve 108 and the white light tuning curve 120 to the BBC 102 shown in FIG. 1.

By introducing a Duv adjustment light (e.g., a purple light or a second green light) to a warm white light having a warm CCT value (e.g., 2700K), the warm CCT value of the warm white light may be moved to a location on or otherwise within a Duv threshold of the BBC 102. By introducing a Duv adjustment light (e.g., the purple light or the second green light) to a cool white light having a cool CCT value (e.g., 6500K), the cool CCT value of the cool white light may be moved to a location on or otherwise within a Duv threshold of the BBC 102. By introducing one or more Duv adjustment lights (e.g., a purple light and/or a second green light) to a warm white light having a warm CCT value (e.g., 2700K), to a cool white light having a cool CCT value (e.g., 6500K), and to a green light having the green flux Ø_{G} that is controlled based on a lookup table (e.g., Table 1), a white light tuning curve of a resulting combined light may be closer to the BBC 102 than a white light tuning curve that is not based on the one or more Duv adjustment lights.

In some alternative embodiments, the warm CCT point 104 and the cool CCT point 106 may be at different locations than shown without departing from the scope of this disclosure. In some alternative embodiments, the MacAdam ellipses 122, 124 may each have a different elliptical shape than shown without departing from the scope of this disclosure. The locations 110, 112, 116, 118, 128, 130 in the MacAdam ellipse 122 or 124 may be at different locations than shown without departing from the scope of this disclosure. In some alternative embodiments, another light instead of a purple light may be used without departing from the scope of this disclosure. In some alternative embodiments, another light instead of a green light may be used without departing from the scope of this disclosure.

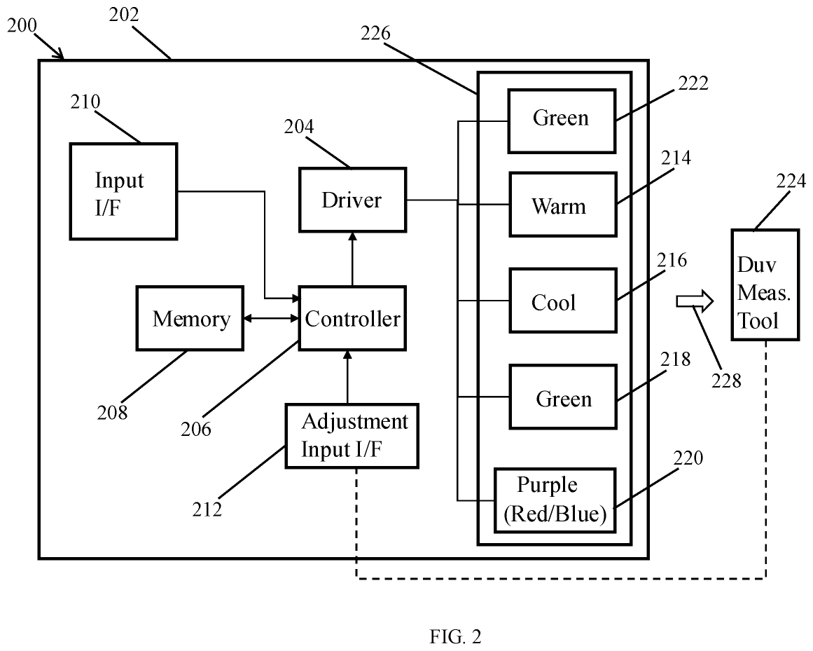

FIG. 2 illustrates a system 200 including a lighting device 202 and a Duv measurement device 224 for determining maximum flux value of Duv adjustment flux according to an example embodiment. Referring to FIGS. 1 and 2, in some example embodiments, the lighting device 202 may include a driver 204 (e.g., an LED driver), a controller 206, a memory device 208 (e.g., a flash memory device), and an input interface 210. The lighting device 202 may also include an adjustment input interface 212 and a light module 226. The controller 206 may include a microprocessor or a microcontroller that executes software code stored in the memory device 208 and use other data stored in the memory device 208 to perform operations described herein with respect to the controller 206. For example, one or more lookup tables (e.g., Table 1) and other data may be stored in the memory device 208, and the controller 206 may use the information to control a light 228 provided by the lighting device 202. To illustrate, the input interface 210 may include a wired and/or wireless communication unit that receives user inputs, such as dim level setting input and CCT setting input, and the controller 206 may control the driver 204 and/or the light module 226 based on the user inputs to control the light 228 that is provided by the light module 226. Alternatively or in addition, the input interface 210 may include a physical user input interface (e.g., a dipswitch, a knob, etc.) for a user to provide direct inputs to the lighting device 202.

In some example embodiments, the light module 226 may include warm CCT LEDs 214, cool CCT LEDs 216, and green light LEDs 218. The warm CCT LEDs 214 may emit a warm white light having a warm CCT (e.g., 2700K, 3000K) and may have the warm flux Ø_{2700K} described above with respect to FIG. 1 and Tables 1 and 2. The amount of the warm flux Ø_{2700K} depends on the current flowing through the warm CCT LEDs 214. The cool CCT LEDs 216 may emit a cool white light having a cool CCT (e.g., 5000K, 6000K, 6500K) and may have the cool flux Ø_{6500K} described above with respect to FIG. 1 and Tables 1 and 2. The green light LEDs 218 may emit a green light (i.e., a light having the wavelength of a green light in the visible light spectrum) and may have the green flux Ød described above with respect to FIG. 1 and Tables 1 and 2. For example, the green light may be a phosphor converted green light.

In general, the amount of the warm flux Ø_{2700K}, the amount of the cool flux Ø_{6500K}, and the amount of the green flux OG depend on the current flowing through the warm CCT LEDs 214, the cool CCT LEDs 216, and the green light LEDs 218, respectively. As described above, the amount of the green flux OG is controlled based on the amount of the warm flux Ø_{2700K} or the cool flux Ø_{6500K} as provided by a lookup table such as Table 1. To illustrate, the controller 206 may control the amount of current flowing through each one of the warm CCT LEDs 214 and the cool CCT LEDs 216 based on a CCT setting input provided via the input interface 210. The controller 206 may control the amount of current flowing through the green light LEDs 218 based on a lookup table (e.g., Table 1) that indicates the amount of the green flux OG mapped to the amount of the warm flux Ø_{2700K} and/or the amount of the cool flux Ø_{6500K}.

In some example embodiments, the light module 226 may include purple light LEDs 220 and second green light LEDs 222. The purple light LEDs 220 may provide a purple light resulting from a mix of blue light and red light. For example, the purple light LEDs 220 may include some LEDs that emit the blue light and some LEDs that emit the red light. The second green light LEDs 222 may emit a second green light. For example, the purple light and the second green light can serve as Duv adjustment lights as described above with respect to FIG. 1. The controller 206 may control the amount of current provided to the purple light LEDs 220 and to the second green light LEDs 222.

To illustrate, the controller 206 may control the flux of the purple light (i.e., the amount of the purple flux) by controlling the amount of current provided to the purple light LEDs 220. As described above, the purple light, used as a Duv adjustment light, may be combined with the warm white light emitted by the warm CCT LEDs 214, where a maximum flux value of the purple flux (i.e., maximum flux value of the adjustment flux amount) may result in a combined light (i.e., the combination of the warm white light and the purple light) that has the warm CCT value (e.g., 2700K) located on the BBC 102 (e.g., at the location 116). For example, the warm CCT value of the warm white light may be at the location 110 in the MacAdam ellipse 122.

In some example embodiments, the maximum flux value of the purple flux with respect to the warm CCT value may be determined using the Duv measurement device 224 (e.g., a spectrometer). To illustrate, the controller 206 may control the currents provided to the cool CCT LEDs 216, the green light LEDs 218, and the second green light LEDs 222 such that the cool white light, the green light, and the second green light are off. While the cool white light, the green light, and the second green light are off, the controller 206 may control the current provided to the warm CCT LEDs 214 such that the warm white light has a maximum flux value of the warm flux Ø_{2700K} as shown, for example, in last row of Table 1. While the cool white light, the green light, and the second green light are off and while the warm flux Ø_{2700K} has the maximum value, the controller 206 may iteratively adjust the current provided to the purple light LEDs 220 based on the Duv measurement value indicated by the Duv measurement device 224 that may continuously measure the Duv of the CCT of the light 228 provided by the lighting device 202.

To illustrate, when the cool white light, the green light, and the second green light are off and the warm white light and the purple light are on, the light 228 includes the warm white light and the purple light. The Duv measurement device 224 may measure the Duv of the CCT of the light 228, and the measured Duv value may be, for example, continuously provided to the controller 206 via the adjustment input interface 212. The controller 206 may accordingly adjust (i.e., increase or decrease) the current provided to the purple light LEDs 220 by the driver 204 to change the flux of the purple light iteratively until the Duv of the CCT of the light 228 is less than or equal to a threshold value (e.g., 0.001, 0.003, etc.). The particular amount of the current provided to the purple light LEDs 220 that results in the Duv of the CCT of the light 228 being less than or equal to the threshold value corresponds to the maximum flux value of the purple flux with respect to the warm CCT value and the warm white light. As described with respect to FIG. 1, the maximum flux value of the purple flux with respect to the warm CCT value and the warm white light is the amount of the purple flux that results in the combined light resulting from the combination of the warm white light and the purple light having the warm CCT on or close to the BBC 102 (e.g., at the location 116) instead of, for example, at the location 110.

In some example embodiments, the controller 206 may store in the memory device 208 one or more values corresponding to or otherwise indicative of the particular current amount and/or the maximum flux value of the purple flux with respect to the warm CCT value and the warm white light as determined through the use of the Duv measurement device 224. For example, Table 2 shows, in each row of the column labeled Ø_{2700K}-Nulled, a value corresponding to the purple flux with respect to the warm CCT value combined with a value corresponding to the warm flux Ø_{2700K}. To illustrate, the example value, 104.7%, in the last row of Table 2 under the Ø_{2700K}-Nulled column includes 100% as the warm flux Ø_{2700K} expressed as a percentage of the sum of the warm flux Ø_{2700K} and the cool flux Ø_{6500K} (i.e., the cool flux Ø_{6500K} equals zero), and 4.7% as the purple flux amount expressed as a percentage of the warm flux Ø_{2700K} when the cool flux Ø_{6500K} equals zero. The value, 4.7%, is the maximum flux value of the purple flux with respect to the warm CCT value and the warm white light as determined through the use of the Duv measurement device 224. Because the warm flux Ø_{2700K} is 100% of the sum of the warm flux Ø_{2700K} and the cool flux Ø_{6500K}, the purple flux amount is 100% of the maximum flux value of the purple flux as determined through the use of the Duv measurement device 224.

In some example embodiments, when the warm flux Ø_{2700K} is 90% of the sum of the warm flux Ø_{2700K} and the cool flux Ø_{6500K} (i.e., the cool flux Ø_{6500K} is 10% of the sum), the value corresponding to the purple flux with respect to the warm CCT value is the same percentage, i.e., 90%, of the maximum flux value (i.e., 4.7%) of the purple flux. As another example, when the warm flux Ø_{2700K} is 30% of the sum of the warm flux Ø_{2700K} and the cool flux Ø_{6500K} (i.e., the cool flux Ø_{6500K} is 70% of the sum), the value corresponding to the purple flux with respect to the warm CCT value is the same percentage, i.e., 30%, of the maximum flux value (i.e., 4.7%) of the purple flux. In general, in Table 2, each row under the Ø_{2700K}-Nulled column may include a sum of a value corresponding to the warm flux Ø_{2700K} and a value corresponding to the purple flux with respect to the warm CCT value.

In some example embodiments, the controller 206 may control the currents provided to the cool CCT LEDs 216, the green light LEDs 218, and the second green light LEDs 222 such that the warm white light, the green light, and the second green light are off. While the warm white light, the green light, and the second green light are off, the controller 206 may control the current provided to the cool CCT LEDs 216 such that the cool flux Ø_{6500K} of the cool white light has a maximum flux value as shown, for example, in first row of Table 1. While the warm white light, the green light, and the second green light are off and while the cool flux Ø_{6500K} has the maximum value, the controller 206 may iteratively adjust the current provided to the purple light LEDs 220 based on the Duv measurement value indicated by the Duv measurement device 224 that may continuously measure the Duv of the CCT of the light 228 provided by the lighting device 202.

To illustrate, when the warm white light, the green light, and the second green light are off and the cool white light and the purple light are on, the light 228 includes the cool white light and the purple light. The Duv measurement device 224 may measure the Duv of the CCT of the light 228, and the measured Duv value may be, for example, continuously provided to the controller 206 via the adjustment input interface 212. The controller 206 may accordingly adjust (i.e., increase or decrease) the current provided to the purple light LEDs 220 by the driver 204 to change the flux of the purple light iteratively until the Duv of the CCT of the light 228 is less than or equal to a threshold value (e.g., 0.001, 0.003, etc.). The particular amount of the current provided to the purple light LEDs 220 that results in the Duv of the CCT of the light 228 being less than or equal to the threshold value corresponds to the maximum flux value of the purple flux with respect to the cool CCT value and the cool white light. As described with respect to FIG. 1, the maximum flux value of the purple flux with respect to the cool CCT value and the cool white light is the amount of the purple flux that results in the combined light resulting from the combination of the cool white light and the purple light having the cool CCT on or close to the BBC 102 (e.g., at the location 118) instead of, for example, at the location 112.

In some example embodiments, the controller 206 may store in the memory device 208 one or more values corresponding to or otherwise indicative of the particular current amount and/or the maximum flux value of the purple flux with respect to the cool CCT value and the cool white light as determined through the use of the Duv measurement device 224. For example, Table 2 shows, in each row of the column labeled Ø_{6500K}-Nulled, a value corresponding to the purple flux with respect to the cool CCT value combined with a value corresponding to the cool flux Ø_{6500K}. For example, the example value, 104.0%, in the first row of Table 2 under the Ø_{6500K}-Nulled column includes 100% as the value corresponding to the cool flux Ø_{6500K} expressed as a percentage of the sum of the warm flux Ø_{2700K} and the cool flux Ø_{6500K} (i.e., the warm flux Ø_{2700K} equals zero), and 4.0% as a value corresponding to the purple flux amount expressed as a percentage of the cool flux Ø_{6500K} when the warm flux Ø_{2700K} equals zero. The value, 4.0%, is the maximum flux value of the purple flux with respect to the cool CCT value and the cool white light as determined through the use of the Duv measurement device 224. Because the cool flux Ø_{6500K} is 100% of the sum of the warm flux Ø_{2700K} and the cool flux Ø_{6500K}, the value (i.e., 4.0%) corresponding to the purple flux amount is 100% of the maximum flux value of the purple flux as determined through the use of the Duv measurement device 224.

In some example embodiments, when the warm flux Ø_{2700K} is 90% of the sum of the warm flux Ø_{2700K} and the cool flux Ø_{6500K} (i.e., the warm flux Ø_{2700K} is 10% of the sum), the value corresponding to the purple flux with respect to the cool CCT value is the same percentage, i.e., 90%, of the maximum flux value of the purple flux with respect to the cool CCT value and the cool white light. As another example, when the cool flux Ø_{6500K} is 70% of the sum of the warm flux Ø_{2700K} and the cool flux Ø_{6500K} (i.e., the warm flux Ø_{2700K} is 30% of the sum), the value corresponding to the purple flux with respect to the cool CCT value is the same percentage, i.e., 70%, of the maximum flux value of the purple flux with respect to the cool CCT value. In general, in Table 2, each row under the Ø_{6500K}-Nulled column may include a sum of a value corresponding to the cool flux Ø_{6500K} and a value corresponding to the purple flux with respect to the cool CCT value.

In some example embodiments, after the values corresponding the purple flux amount with respect to the warm CCT value and/or the values corresponding to the purple flux amount with respect to the cool CCT value are determined and stored in the memory device 208, the controller 206 may use the stored values to control the total flux (i.e., an adjustment total flux) of the purple light by controlling current flow through the purple light LEDs 220 based on the values corresponding to the warm flux Ø_{2700K} or the values corresponding to the cool flux Ø_{6500K}. In general, the purple light may have a total flux (i.e., the adjustment total flux) that is the sum of (1) a first purple flux amount (i.e., a first adjustment flux amount) having a maximum flux value with respect to the warm CCT value and the warm white light and (2) a second purple flux amount (i.e., a second adjustment flux amount) having a maximum flux value with respect to the cool CCT value and the cool white light.

In some example embodiments, the second green light emitted by the second green light LEDs 222 instead of the purple light emitted by the purple light LEDs 220 may be needed to produce a combined light having a warm CCT value that is on the BBC 102. The maximum flux value of the green flux of the second green light (i.e., the second green flux) with respect to the warm CCT value may be determined using the Duv measurement device 224. To illustrate, the controller 206 may control the currents provided to the cool CCT LEDs 216, the green light LEDs 218, and the purple light LEDs 220 such that the cool white light, the green light, and the purple light are off. While the cool white light, the green light, and the purple light are off, the controller 206 may control the current provided to the warm CCT LEDs 214 such that the warm white light has a maximum flux value of the warm flux Ø_{2700K} as shown, for example, in last row of Table 1. While the cool white light, the green light, and the purple light are off and while the warm flux Ø_{2700K} has the maximum value, the controller 206 may iteratively adjust the current provided to the second green light LEDs 222 based on the Duv measurement value indicated by the Duv measurement device 224 that may continuously measure the Duv of the CCT of the light 228 provided by the lighting device 202.

To illustrate, when the cool white light, the green light, and the purple light are off and the warm white light and the second green light are on, the light 228 includes the warm white light and the second green light. The Duv measurement device 224 may measure the Duv of the CCT of the light 228, and the measured Duv value may be, for example, continuously provided to the controller 206 via the adjustment input interface 212. The controller 206 may accordingly adjust (i.e., increase or decrease) the current provided to the second green LEDs 222 by the driver 204 to change the flux of the second green light iteratively until the Duv of the CCT of the light 228 is less than or equal to a threshold value (e.g., 0.001, 0.003, etc.). The particular amount of the current provided to the second green light LEDs 222 that results in the Duv of the CCT of the light 228 being less than or equal to the threshold value corresponds to the maximum flux value of the second green flux with respect to the warm CCT value and the warm white light. As described with respect to FIG. 1, the maximum flux value of the second (i.e., additional) green flux with respect to the warm CCT value and the warm white light is the amount of the second green flux that results in the combined light (i.e., the combination of the warm white light and the second green light) having the warm CCT on or close to the BBC 102 instead of, for example, at the location 128. The controller 206 may store in the memory device 208, with respect to the warm CCT value/the warm white light, the maximum flux value of the second green flux and other values of the second green flux determined in the same manner as described above with respect to the purple light emitted by the purple light LEDs 220.

In some example embodiments, the second green light emitted by the second green light LEDs 222 instead of the purple light emitted by the purple light LEDs 220 may be needed to produce a combined light having a cool CCT value that is on the BBC 102. The maximum flux value of the green flux of the second green light (i.e., the second green flux) with respect to the cool CCT value may be determined using the Duv measurement device 224. To illustrate, the controller 206 may control the currents provided to the cool CCT LEDs 216, the green light LEDs 218, and the purple light LEDs 220 such that the warm white light, the green light, and the purple light are off. While the warm white light, the green light, and the purple light are off, the controller 206 may control the current provided to the cool CCT LEDs 216 such that the cool flux Ø_{6500K} of the cool white light has a maximum flux value. While the warm white light, the green light, and the second green light are off and while the cool flux Ø_{6500K} has the maximum value, the controller 206 may iteratively adjust the current provided to the purple light LEDs 220 based on the Duv measurement value indicated by the Duv measurement device 224 that may continuously measure the Duv of the CCT of the light 228 provided by the lighting device 202.

To illustrate, when the warm white light, the green light, and the purple light are off and the cool white light and the second green light are on, the light 228 includes the cool white light and the second green light. The Duv measurement device 224 may measure the Duv of the CCT of the light 228, and the measured Duv value may be, for example, continuously provided to the controller 206 via the adjustment input interface 212. The controller 206 may accordingly adjust (i.e., increase or decrease) the current provided to the second green light LEDs 222 by the driver 204 to change the flux of the second green light iteratively until the Duv of the CCT of the light 228 is less than or equal to a threshold value (e.g., 0.001, 0.003, etc.). The particular amount of the current provided to the second green light LEDs 222 that results in the Duv of the CCT of the light 228 being less than or equal to the threshold value corresponds to the maximum flux value of the second green flux with respect to the cool CCT value and the cool white light. As described with respect to FIG. 1, the maximum flux value of the purple flux with respect to the cool CCT value and the cool white light is the amount of the second green flux that results in the combined light resulting from the combination of the cool white light and the second green light having the cool CCT on or close to the BBC 102 instead of, for example, at the location 130. The controller 206 may store in the memory device 208, with respect to the cool CCT value/the cool white light, the maximum flux value of the second green flux and other values of the second green flux determined in the same manner as described above with respect to the purple light emitted by the purple light LEDs 220.

In some example embodiments, after the values corresponding to the second green flux amount with respect to the warm CCT value/the warm white light and/or the values corresponding to the second green flux amount with respect to the cool CCT value/the cool white light are stored in the memory device 208, the controller 206 may use the stored values to control the total flux (i.e., an adjustment total flux) of the second green light by controlling current flow through the second green light LEDs 222 based on the values corresponding to the warm flux Ø_{2700K} or the values corresponding to the cool flux Ø_{6500K}. In general, the purple light may have a total flux (i.e., the adjustment total flux) that is the sum of (1) a first second green flux amount (i.e., a first adjustment flux amount) having a maximum flux value with respect to the warm CCT value and the warm white light and (2) a second green flux amount (i.e., a second adjustment flux amount) having a maximum flux value with respect to the cool CCT value and the cool white light.

The controller 206 may control the amount of flux of the purple light and/or the second green light such that the warm CCT value (e.g., 2700K) of the warm white light emitted by the warm CCT LEDs 214 is at a location (e.g., the location 116) on or otherwise within a Duv threshold of the BBC 102. The controller 206 may also control the amount of flux of the purple light and/or the second green light such that the cool CCT value (e.g., 6500K) of the cool white light emitted by the cool CCT LEDs 216 is at a location (e.g., the location 118) on or otherwise within a Duv threshold of the BBC 102. The controller 206 may control the amount of flux of the purple light and/or the second green light in addition to the warm white light, the cool white light, and the green light emitted by the green light LEDs 218 having the green flux Ø_{G} controlled based on a lookup table (e.g., Table 1) such that a white light tuning curve of a resulting combined light is closer to the BBC 102 than the white light tuning curves 108, 114, 120.

In some alternative embodiments, the system 200 may include other components than shown without departing from the scope of this disclosure. In some alternative embodiments, the Duv measurement device 224 may be integrated in the lighting device 202. In some alternative embodiments, the lighting device 202 may include components other than shown without departing from the scope of this disclosure. In some alternative embodiments, some of the components of the lighting device 202 may be integrated in a single component or may be connected in a different configuration than shown without departing from the scope of this disclosure.

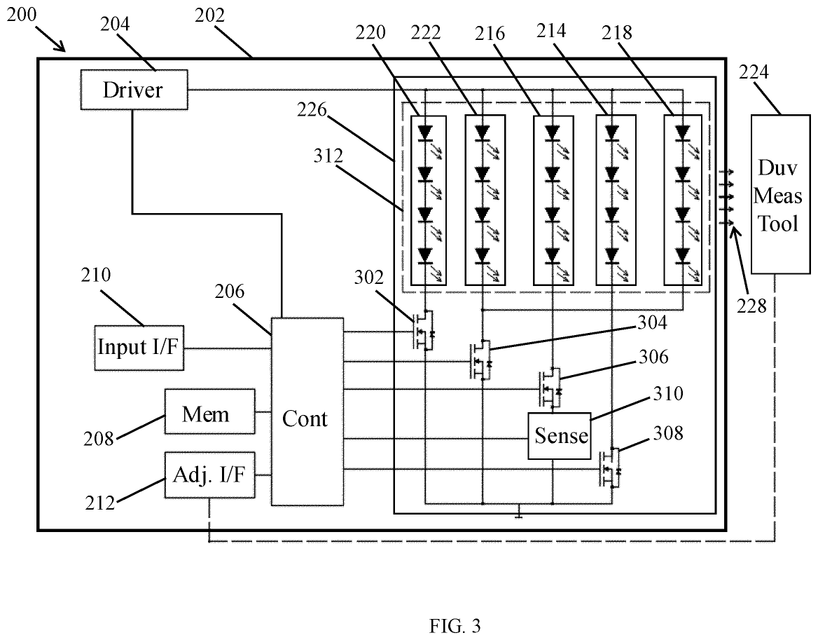

FIG. 3 illustrates the system 200 of FIG. 2 including details of the lighting device 202 according to an example embodiment. Referring to FIGS. 1-3, in some example embodiments, the system 200 includes the lighting device and the Duv measurement device 224. The lighting device 202 may include the lighting device 202 may include the driver 204, the controller 206, the memory device 208, the input interface 210, the adjustment input interface 212, and the light module 226. The light module 226 may include the light source unit 312 that includes the warm CCT LEDs 214, the cool CCT LEDs 216, the green light LEDs 218, the purple light LEDs 220, and the second green light LEDs 222.

In some example embodiments, the light module 226 includes a transistor 302 that is coupled to the purple light LEDs 220, and the controller 206 may control current flow through the purple light LEDs 220 by controlling transistor 302 as can be readily understood by those of ordinary skill in the art with the benefit of this disclosure. The light module 226 may also include a transistor 304 that is coupled to the green light LEDs 218 and the second green light LEDs 222, and the controller 206 may control current flow through the green light LEDs 218 and the second green light LEDs 222 by controlling transistor 304 as can be readily understood by those of ordinary skill in the art with the benefit of this disclosure. The light module 226 may include a transistor 306 that is coupled to the cool CCT LEDs 216, and the controller 206 may control current flow through the cool CCT LEDs 216 by controlling transistor 306 as can be readily understood by those of ordinary skill in the art with the benefit of this disclosure. The light module 226 may include a transistor 308 that is coupled to the warm CCT LEDs 214, and the controller 206 may control current flow through the warm CCT LEDs 214 by controlling transistor 308 as can be readily understood by those of ordinary skill in the art with the benefit of this disclosure.

In some example embodiments, the light module 226 may include a current sensor 310 that provides to the controller 206 an output indicative of the amount of current through the cool CCT LEDs 216. For example, the controller 206 may use the output of the current sensor 310 and the information in the lookup table (e.g., Table 1) along with the stored information indicating the amount of purple flux and/or the amount of second green flux to control the amount of current through the warm CCT LEDs 214, the cool CCT LEDs 216, the green light LEDs 218, the purple light LEDs 220, and the second green light LEDs 222. Alternatively, the current sensor 310 may be coupled to the warm CCT LEDs 214, and the controller 206 may use the output of the current sensor 310 to control the amount of current through the warm CCT LEDs 214, the cool CCT LEDs 216, the green light LEDs 218, the purple light LEDs 220, and the second green light LEDs 222.

In some alternative embodiments, the light module 226 may include separate transistors for the green light LEDs 218 and the second green light LEDs 222. In some alternative embodiments, the transistor 302, 304, 306, 308 may be omitted, and the driver 204 may include separate channels that each are coupled to a respective one of the warm CCT LEDs 214, the cool CCT LEDs 216, the green light LEDs 218, the purple light LEDs 220, and the second green light LEDs 222 without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

1. A lighting device, comprising:
a memory device;
a controller in communication with or including the memory device;
first light emitting diodes (LEDs) configured to emit a warm white light having a warm correlated color temperature (CCT) value;
second LEDs configured to emit a cool white light having a cool CCT value;
green light LEDs configured to emit a green light having a green light flux, wherein the green light flux is controlled, by the controller, based on a flux of the cool white light or a flux of the warm white light and wherein values corresponding to the green light flux are obtained by the controller from a lookup table (Table 1, Table 2) stored in the memory device that includes the values corresponding to the green light flux and values corresponding to the flux of the cool white light or the flux of the warm white light; and
third LEDs configured by the controller to emit a delta u,v (Duv) adjustment light having an adjustment total flux that includes an adjustment flux amount, the adjustment flux amount having a maximum flux value that is determined by iteratively adjusting the adjustment flux amount, while the cool white light and the green light are off, until a Duv of a combined light that includes the warm white light and the Duv adjustment light is less than a threshold value, wherein, after the maximum flux value is determined, the adjustment flux amount is controlled based on the maximum flux value and based on the values corresponding to the flux of the cool white light or the values corresponding to the flux of the warm white light.

2. The lighting device of claim 1, wherein the combined light has a second warm CCT value and wherein the warm CCT value and the second warm CCT value are in a seven-step MacAdam ellipse having a warm CCT center value.

3. The lighting device of claim 2, wherein the warm CCT center value is in a range of 2500K to 3000K.

4. The lighting device of claim 1, wherein the adjustment total flux includes a second adjustment flux having a second maximum flux value that is determined by iteratively adjusting the second adjustment flux amount, while the warm white light and the green light are off, until a Duv of a second combined light that includes the cool white light and the Duv adjustment light is less than a second threshold value and wherein, after the second maximum flux value is determined, the second adjustment flux amount is controlled based on the second maximum flux value and based on the values corresponding to the flux of the cool white light or the values corresponding to the flux of the warm white light.

5. The lighting device of claim 4, wherein the second combined light has a second cool CCT value and wherein the cool CCT value and the second cool CCT value are in a seven-step MacAdam ellipse having a cool CCT center value.

6. The lighting device of claim 5, wherein the cool CCT center value is in a range of 6000K to 7000K.

7. The lighting device of claim 4, wherein the Duv adjustment light is a purple light.

8. The lighting device of claim 4, wherein the Duv adjustment light is a second green light.

9. The lighting device of claim 1, further comprising fourth LEDs configured to emit a second Duv adjustment light having a second adjustment total flux that includes a second adjustment flux amount, the second adjustment flux amount having a second maximum flux value that is determined by iteratively adjusting the second adjustment flux amount, while the warm white light, the green light, and the Duv adjustment light are off, until a Duv of a second combined light that includes the cool white light and the Duv adjustment light is less than a second threshold value, wherein, after the second maximum flux value is determined, the second adjustment flux amount is controlled based on the second maximum flux value and based on the values corresponding to the flux of the cool white light or the values corresponding to the flux of the warm white light.

10. The lighting device of claim 9, wherein the second combined light has a second cool CCT value and wherein the cool CCT value and the second cool CCT value are in a seven-step MacAdam ellipse having a cool CCT center value.

11. The lighting device of claim 10, wherein the cool CCT center value is in a range of 6000K to 7000K.

12. The lighting device of claim 9, wherein the Duv adjustment light is a purple light and the second Duv adjustment light is a second green light.

13. The lighting device of claim 9, wherein the Duv adjustment light is a second green light and the second Duv adjustment light is a purple light.

14. The lighting device of claim 1, wherein the values corresponding to the flux of the warm white light and the values corresponding to the flux of the cool white light are duty cycle values, normalized flux values, or percentage values with respect to a sum total flux that is a sum of at least the flux of the cool white light and the flux of the warm white light.
